(19) United States
(12) Patent Application Publication
(10) Pub. No.: US 2021/0343229 A1
(43) Pub. Date: Nov. 4, 2021

(54) PIXEL DRIVE CIRCUIT AND DISPLAY PANEL

(71) Applicant: (SHENZHEN CHINA STAR OPTOELECTRONICS SEMICONDUCTOR DISPLAY TECHNOLOGY CO., LTD.), Shenzhen (CN)

(72) Inventors: Bo YANG, Shenzhen (CN); Pengfei LIANG, Shenzhen (CN)

(21) Appl. No.: 16/625,119

(22) PCT Filed: Nov. 21, 2019
(86) PCT No.: PCT/CN2019/119871

§ 371 Date: Dec. 20, 2019

(30) Foreign Application Priority Data
Nov. 11, 2019 (CN) 201911094712.3

(51) Int. Cl. G09G 3/32

(52) U.S. Cl. CPC G09G 3/32; G09G 2320/0233; G09G 2310/08; G09G 2300/0426; G09G 2300/0842

(57) ABSTRACT

A pixel drive circuit and a display panel are provided. The pixel drive circuit includes a reference voltage input module for inputting a reference voltage and for controlling the light-emitting module not to emit light, a light-emitting module for emitting light, a sensing module for sensing a threshold voltage of the light-emitting module, a storage capacitor module storing the threshold voltage of the light-emitting module, and a digital signal input module for inputting a data signal. The pixel drive circuit can improve uniformity of the picture and achieve high contrast at the same time, and the display effect is improved.

### BACKGROUND

### 1. Field of the Invention

The present disclosure relates to the field of display technology, more particularly, to a pixel drive circuit and a display panel.

### 2. Description of the Related Art

Light-emitting diodes (LEDs) have the characteristics of high brightness and long life and are widely used in the field of display technology. Due to the lower contrast of LEDs at low gray levels, the drive method for the LEDs in the related art adopts a pulse width modulation (PWM) dimming technology to shorten the light-emitting time of the LEDs so as to achieve a more precise gray level division. However, this drive method can not compensate for the threshold voltage differences of the drive transistors, which in turn causes uneven brightness of the picture during display.

Therefore, the display panel in the related art has the technical problem that high contrast and uniform brightness can not be achieved at the same time, and needs to be improved

### SUMMARY

The present disclosure provides a pixel drive circuit and a display panel to alleviate the technical problem that the display panel in the related art can not achieve high contrast and uniform brightness at the same time.

In order to resolve the above problem, the present disclosure provides the technical schemes as follows.

The present disclosure provides a pixel drive circuit. The pixel drive circuit comprises: a reference voltage input module configured to input a reference voltage to a first node under a control of a first control signal in a first working state; a light-emitting module connected to the reference voltage input module through the first node, and being configured to emit light under controls of a second control signal and a potential at the first node; a sensing module connected to the light-emitting module through a second node, and being configured to sense a threshold voltage of the light-emitting module under a control of a third control signal; a storage capacitor module connected to the light-emitting module through the first node, the second node and a third node, and being configured to store the threshold voltage of the light-emitting module; and a digital signal input module connected to the reference voltage input module and the light-emitting module through the first node, and being configured to input a data signal to the first node under a control of a fourth control signal in a second working state. The reference voltage input module is further configured to input the reference voltage to the first node under the control of the first control signal in a third working state after the light-emitting module emits light, so as to control the light-emitting module not to emit light.

In the pixel drive circuit, the reference voltage input module comprises a first transistor, a gate of the first transistor is connected to the first control signal, a first electrode of the first transistor is connected to a reference voltage input terminal, a second electrode of the first transistor is connected to the first node.

In the pixel drive circuit, the light-emitting module comprises a second transistor, a third transistor and a light-emitting diode, a gate of the second transistor is connected to the second control signal, a first electrode of the second transistor is connected to the third node and a first power signal, a second electrode of the second transistor is connected to a first electrode of the third transistor, a gate of the third transistor is connected to the first node, a second electrode of the third transistor is connected to the second node and an anode of the light-emitting diode, a cathode of the light-emitting diode is connected to a second power signal.

In the pixel drive circuit, the sensing module comprises a fourth transistor, a gate of the fourth transistor is connected to the third control signal, a first electrode of the fourth transistor is connected an initial voltage input terminal, a second electrode of the fourth transistor is connected to the second node.

In the pixel drive circuit, the storage capacitor module comprises a first storage capacitor and a second storage capacitor, a first electrode plate of the first storage capacitor is connected to the first node, a second electrode plate of the first storage capacitor is connected to a first electrode plate of the second storage capacitor through the second node, a second electrode plate of the second storage capacitor is connected to the third node.

In the pixel drive circuit, the digital signal input module comprises a fifth transistor, a gate of the fifth transistor is connected to the fourth control signal, a first electrode of the fifth transistor is connected to a data line, a second electrode of the fifth transistor is connected to the first node.

In the pixel drive circuit, the reference voltage input module is configured to input the reference voltage to the first node under the control of the high-level first control signal in the first working state and the third working state.

In the pixel drive circuit, the reference voltage input module is configured to input the high-level reference voltage in the first working state.

In the pixel drive circuit, the reference voltage input module is configured to input the high-level reference voltage in the third working state.

In the pixel drive circuit, the first control signal, the second control signal, the third control signal, and the fourth control signal are generated by a timing controller.

The present disclosure further provides a display panel. The display panel comprises the pixel drive circuit as stated above.

The present disclosure provides a pixel drive circuit and a display panel. The pixel drive circuit comprises: a reference voltage input module configured to input a reference voltage to a first node under a control of a first control signal in a first working state; a light-emitting module connected to the reference voltage input module through the first node, and being configured to emit light under controls of a second control signal and a potential at the first node; a sensing module connected to the light-emitting module through a second node, and being configured to sense a threshold voltage of the light-emitting module under a control of a third control signal; a storage capacitor module connected to the light-emitting module through the first node, the second node and a third node, and being configured to store the threshold voltage of the light-emitting module; and a digital signal input module connected to the reference voltage input module and the light-emitting module through the first node, and being configured to input a data signal to the first node under a control of a fourth control signal in a second working state. The reference voltage input module is further configured to input the reference voltage to the first node under the control of the first control signal in a third working state after the light-emitting module emits light, so as to control the light-emitting module not to emit light. According to the present disclosure, the threshold voltage of the light-emitting module is obtained and stored in the first working state, the threshold voltage differences can be compensated for after the data signal is written in the second working state, and the light-emitting module can be controlled by inputting the reference voltage to stop emitting light in the third working state. The light-emitting time is shortened. As a result, the pixel drive circuit according to the present disclosure can improve uniformity of the picture and achieve high contrast at the same time, and the display effect is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural schematic diagram of a pixel drive circuit according to one embodiment of the present disclosure.

FIG. 2 is a timing diagram of various signals of a pixel drive circuit according to one embodiment of the present disclosure.

FIG. 3 is a schematic diagram showing a comparison of contrasts between PWM dimming and non-PWM dimming.

FIG. 4 is a structural schematic diagram of a pixel drive circuit in the related art.

FIG. 5 is a schematic diagram of comparison of dimming time zones and light-emitting time zones according to the related art and the present disclosure.

### DESCRIPTION OF THE EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

The present disclosure provides a pixel drive circuit and a display panel to alleviate the technical problem that the display panel in the related art can not achieve high contrast and uniform brightness at the same time.

LED elements have the characteristics of high brightness and long life and are widely used in the field of display technology. Due to the lower contrast of LEDs at low gray levels, the drive method for the LEDs in the related art adopts a PWM dimming technology to shorten the light-emitting time of the LEDs so as to achieve a more precise gray level division. However, this drive method can not compensate for the threshold voltage differences of the drive transistors, which in turn causes uneven brightness of the picture during display.

Therefore, the display panel in the related art has the technical problem that high contrast and uniform brightness can not be achieved at the same time, and needs to be improved.

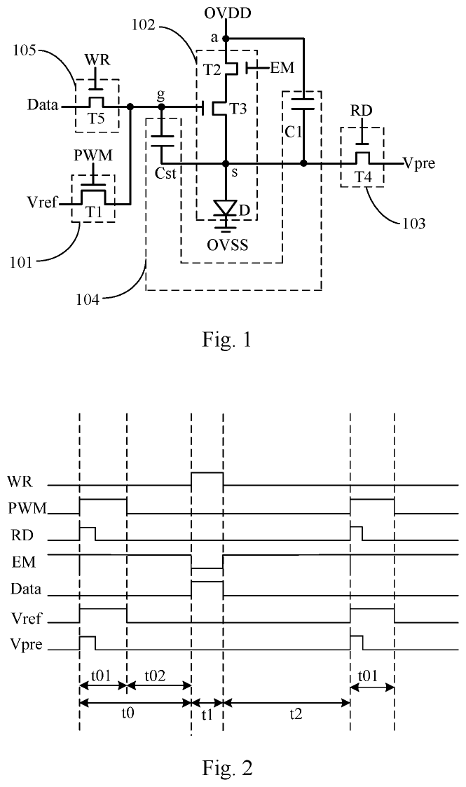

A description is provided with reference to FIG. 1. FIG. 1 is a structural schematic diagram of a pixel drive circuit according to one embodiment of the present disclosure. The pixel drive circuit comprises a reference voltage input module 101, a light-emitting module 102, a sensing module 103, a storage capacitor module 104 and a digital signal input module 105.

The reference voltage input module 101 is configured to input a reference voltage Vref to a first node g under a control of a first control signal PWM in a first working state.

The light-emitting module 102 is connected to the reference voltage input module 101 through the first node g, and is configured to emit light under controls of a second control signal EM and a potential at the first node g.

The sensing module 103 is connected to the light-emitting module 102 through a second node s, and is configured to sense a threshold voltage Vth of the light-emitting module 102 under a control of a third control signal RD.

The storage capacitor module 104 is connected to the light-emitting module 102 through the first node g, the second node s and a third node a, and is configured to store the threshold voltage Vth of the light-emitting module 102.

The digital signal input module 105 is connected to the reference voltage input module 101 and the light-emitting module 102 through the first node g, and is configured to input a data signal Data to the first node g under a control of a fourth control signal WR in a second working state.

The reference voltage input module 101 is further configured to input the reference voltage Vref to the first node g under the control of the first control signal PWM in a third working state after the light-emitting module 102 emits light, so as to control the light-emitting module 102 not to emit light.

In greater detail, the reference voltage input module 101 comprises a first transistor T1. A gate of the first transistor T1 is connected to the first control signal PWM. A first electrode of the first transistor T1 is connected to a reference voltage input terminal. A second electrode of the first transistor T1 is connected to the first node g.

The light-emitting module 102 comprises a second transistor T2, a third transistor T3 and a light-emitting diode D. A gate of the second transistor T2 is connected to the second control signal EN. A first electrode of the second transistor T2 is connected to the third node a and a first power signal OVDD. A second electrode of the second transistor T2 is connected to a first electrode of the third transistor T3. A gate of the third transistor T3 is connected to the first node g. A second electrode of the third transistor T3 is connected to the second node s and an anode of the light-emitting diode D. A cathode of the light-emitting diode D is connected to a second power signal OVSS.

The sensing module 103 comprises a fourth transistor T4. A gate of the fourth transistor T4 is connected to the third control signal RD. A first electrode of the fourth transistor T4 is connected an initial voltage input terminal. A second electrode of the fourth transistor T4 is connected to the second node s.

The storage capacitor module 104 comprises a first storage capacitor Cst and a second storage capacitor C1. A first electrode plate of the first storage capacitor Cst is connected to the first node g. A second electrode plate of the first storage capacitor Cst is connected to a first electrode plate of the second storage capacitor C1 through the second node s. A second electrode plate of the second storage capacitor C1 is connected to the third node a.

The digital signal input module 105 comprises a fifth transistor T5. A gate of the fifth transistor T5 is connected to the fourth control signal WR. A first electrode of the fifth transistor T5 is connected to a data line. A second electrode of the fifth transistor T5 is connected to the first node g.

According to the present disclosure, one of the first electrode and the second electrode of each of the transistors is a source, and another one of the first electrode and the second electrode of the each of the transistors is a drain. The initial voltage input terminal is configured to input an initial voltage Vpre. The data line is configured to input the digital signal Data. The reference voltage input terminal is configured to input the reference voltage Vref. The first power signal OVDD is a high potential power signal, and the second power signal OVSS is a low potential power signal. A voltage value output by the first power signal OVDD is higher than a voltage value output by the second power signal OVSS.

In the light-emitting module 102, the third transistor T3 is a drive transistor. The threshold voltage of the light-emitting module 102 is a threshold voltage Vth of the third transistor T3. All of the first control signal PWM, the second control signal EM, the third control signal RD and the fourth control signal WR are supplied by an timing controller.

FIG. 2 is a timing diagram of various signals of a pixel drive circuit according to one embodiment of the present disclosure. The operations of the pixel drive circuit comprise an initialization stage t0, a data writing stage t1 and a light-emitting stage t2. The initialization stage corresponds to the first working state. The data writing stage t1 corresponds to the second working state. The light-emitting stage t2 corresponds to the third working state.

The initialization stage comprises a threshold voltage extraction stage t01 and a threshold voltage storage stage t02. The threshold voltage extraction stage t01 further comprises a first stage and a second stage.

During the first stage of the threshold voltage extraction stage t01, the first control signal PWM is at a high level. The first transistor T1 is turned on to input the high-level reference voltage Vref to the first node g. The fourth control signal WR is a low-level signal. The fifth transistor T5 is turned off. At this time, a potential at the first node g is Vg=Vref. The third control signal RD is at the high level. The fourth transistor T4 is turned on to input the high-level initial voltage Vpre to the second node s. At this time, a potential at the second node s is Vs=Vpre. A potential difference value between the reference voltage Vref and the initial voltage Vpre is greater than the threshold voltage Vth of the third transistor T3, and a potential of the initial voltage Vpre is less than a threshold voltage Vth1 of the light-emitting diode D, that is, Vref−Vpre>Vth, Vpre<Vth1. At this time, the third transistor T3 is turned on, but no current flows through the light-emitting diode D.

During the second stage of the threshold voltage extraction stage t01, the first control signal PWM and the reference voltage Vref are still at the high level. The fourth control signal WR is still the low-level signal. The potential at the first node g is Vg=Vref. The third transistor T3 is turned on. The third control signal RD is at a low level. The fourth transistor T4 is turned off. Due to the effects of the first storage capacitor Cst and the second storage capacitor C1, the potential at the second node s changes correspondingly until the third transistor T3 is turned off.

At this time, the second electrode of the third transistor T3 starts being charged from the Vpre value of the previous stage. The potential Vs at the second node s gradually rises until the charging is completed when Vref−Vs=Vth. At this time, Vs=Vref−Vth<Vth1. The light-emitting diode D still does not emit light. The sensing module 103 senses the Vpre value at the time when the third transistor T3 completes being charged, and the threshold voltage Vth of the third transistor T3 can be obtained through calculation.

During the threshold voltage storage stage t02, the first control signal PMW, the third control signal RD and the fourth control signal WR are at the low level. The first transistor T1, the fourth transistor T4 and the fifth transistor T5 are turned off. The second control signal EM is at the high level. The second transistor T2 is turned on. Vth is stored across two sides of the first storage capacitor Cst.

During the data writing stage t1, the first control signal PMW and the third control signal RD are at the low level. The first transistor T1 and the fourth transistor T4 are turned off. The second control signal EM is at the low level. The second transistor T2 is turned off. The fourth control signal WR is at the high level. The data line inputs the high-level data signal Data to the first node g. At this time, the potential at the first node g is Vg=Vdata. As compared with the previous stage, a potential change at the first node g is Vdata−Vref. Due to the cooperative coupling effect of the first storage capacitor Cst and the second storage capacitor C1, the potential at the second node s is Vs=(Vref−Vth)+(Vdata−Vref)*Cst/(Cst+C1), where Cst is a capacitance value of the first storage capacitor, and C1 is a capacitance value of the second storage capacitor.

During the light-emitting stage t2, the first control signal PMW, the third control signal RD and the fourth control signal WR are at the low level. The first transistor T1, the fourth transistor T4 and the fifth transistor T5 are turned off. The second control signal EM is at the high level. The second transistor T2 is turned on. The potential at the first node g is at the high level. The third transistor T3 is also turned on. The light-emitting diode D emits light under the controls of the second control signal EM and the potential at the first node g. At this time, the formula of a current I(D) flowing through the light-emitting diode D is:

I(D)=½*K(Vg−Vs−Vth)²,

At this time, Vg=Vdata, Vs=(Vref−Vth)+(Vdata−Vref)*Cst/(Cst+C1). Substitute them into the formula, and the result is:

I(D)=½*K((Vdata−Vref)*Cst/(Cst+C1)−Vref)².

Where K is an intrinsic conductivity factor of the drive thin film transistor, that is, the third transistor T3. It can be seen that the current flowing through the light-emitting diode D is independent of the threshold voltage Vth of the third transistor T3, thus eliminating the influence of the drift of the threshold voltage Vth the drive transistor on the light-emitting diode D. As a result, the display brightness of the display panel can be more uniform to improve the display quality of the display panel.

At a certain time of the light-emitting stage t2, the reference voltage input module 101 inputs the reference voltage Vref to the first node g under the control of the first control signal PWM so as to control the light-emitting module 102 to stop emitting light.

The pixel drive circuit according to the embodiment of the present disclosure is suitable to be applied to an LED display panel. The LED has high brightness, and the conventional LED drive method can not achieve high-precision division at low gray levels, that is, the contrast is lower. Through disposing the reference voltage input module 101, the first control signal PWM can be used to control an input time of the reference voltage Vref to shorten the light-emitting time of the LED so as to achieve a more precise gray level division.

As shown in FIG. 2, the first control signal PWM is a rectangular wave connected to the gate of the first transistor T1 to allow the input reference voltage Vref to be a rectangular wave with a same duty ratio. That is, when the first control signal PWM is at the high level, the reference voltage Vref is also at the high level. When the first control signal PWM is at the low level, the reference voltage Vref is also at the low level. By combining the principles of the above embodiments, the high-level reference voltage Vref interacts with other modules when the first control signal PWM is at the high level, so that the light-emitting diode D does not emit light. The low-level reference voltage Vref interacts with other modules when the first control signal PWM is at the low level, so that the light-emitting diode D emits light.

Therefore, when the pixel drive circuit starts operating, the first control signal PWM that is input is at the high level during the threshold voltage extraction stage t01. The reference voltage input module 101 cooperates with other modules to complete the extraction of the threshold voltage Vth.

After that, during the threshold voltage storage stage t02, the data writing stage t1 and the light-emitting stage t2, the low-level first control signal PWM is input. The storage of the threshold voltage Vth, writing of the data signal Data, and light emitting of the light-emitting diode D are completed.

At any time of the light-emitting stage t2, the first control signal PWM can be changed from the low level to the high level depending on practical needs. At this time, the input reference voltage Vref is also at the high level. The level of each of the signals of the other modules is consistent with that of the threshold voltage extraction stage t01. At this time, the light-emitting diode D stops emitting light. The adjustment of the light-emitting time is achieved by using the first control signal PWM. In addition, before a next frame is displayed and after the light-emitting diode D has finished emitting light, the threshold voltage needs to be extracted and stored once, and the data signal needs to be written once. Therefore, the first control signal PWM at this stage also completes the initialization of the next frame. That is to say, the two tasks of dimming and initialization are completed in the same time period. By disposing the reference voltage input module 101 and performing the adjustment by using the first control signal PWM, the reference voltage input module 101 achieves the functions of dimming and initialization at the same time.

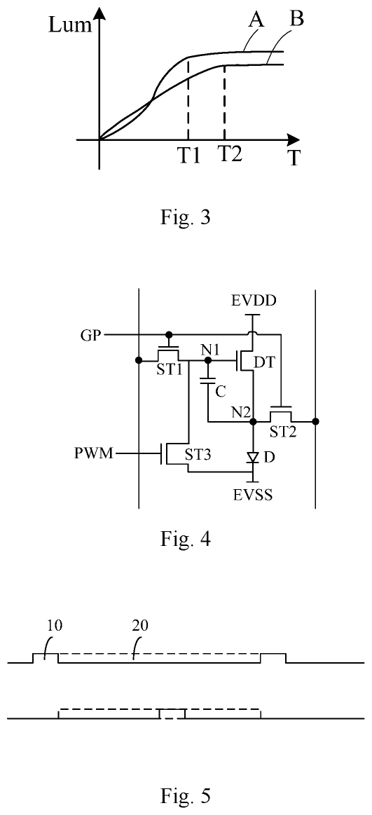

FIG. 3 is a schematic diagram showing comparison of contrasts between PWM dimming and non-PWM dimming. As shown in FIG. 3, curve A is a contrast curve when PWM dimming is not used, and curve B is a contrast curve after dimming when the pixel drive circuit according to the embodiment of the present disclosure is used. The abscissa T represents time, the ordinate Lum represents light intensity, and T1 and T2 respectively represent times to reach stable states adjusted by two types of dimming methods.

It can be seen from the comparison that when PWM dimming is not used, the light intensity of the corresponding pixel is stronger in the stable state. However, after the pixel drive circuit according to the embodiment of the present disclosure is used to perform dimming, the light intensity of the corresponding pixel is weaker in the stable state. That is, a lower brightness is achieved at a low gray level, and a more precise gray level division is achieved. The contrast at low gray levels is increased to improve the display effect.

FIG. 4 is a structural schematic diagram of a pixel drive circuit in the related art. As shown in FIG. 4, the pixel drive circuit comprises a drive transistor DT, a first switch transistor ST1, a second switch transistor ST2, a third switch transistor ST3, a light-emitting diode D and a storage capacitor C. A first electrode of the drive transistor DT is connected to a high power potential EVDD. A second electrode of the drive transistor DT is connected to an anode of the light-emitting diode D. A cathode of the light-emitting diode D is connected to a low power potential EVSS. A gate of the first switch transistor ST1 and a gate of the second switch transistor ST2 are both connected to a fifth control signal GP. A gate of the third switch transistor ST3 is connected to a light dimming signal PWM. A second electrode of the first switch transistor ST1, a gate of the drive transistor DT, a first electrode of the third switch transistor ST3 and a first electrode plate of the storage capacitor C are all connected to a first node N1. A second electrode plate of the storage capacitor C, the second electrode of the drive transistor DT, a second electrode of the second switch transistor ST2 and the anode of the light-emitting diode D are connected to a second node N2.

In the related art, the first electrode and the second electrode of the third switch transistor ST3 are respectively connected to the first node N1 and the low power potential EVSS. The gate of the third switch transistor ST3 performs dimming through connecting the light dimming signal PWM. However, this type of light dimming method performs light dimming on the light-emitting diode D by directly connecting the first node N1 and the low power potential EVSS, so that the light-emitting diode D stops emitting light. The dimming time can only be adjusted before or after the entire light-emitting period of the light-emitting diode D.

FIG. 5 is a schematic diagram of comparison of dimming time zones and light-emitting time zones according to the related art and the present disclosure. From top to bottom, the first group represents the relationship between the dimming time zone 10 and the light-emitting time zone 20 in the related art, and the second group represents the relationship between the dimming time zone 10 and the light-emitting time zone 20 in the present disclosure.

The PWM dimming method in the related art can only perform dimming before or after the light-emitting time zone 20. However, the PWM dimming method according to the present disclosure can perform dimming at any time within the light-emitting time zone 20. The earlier the dimming time is, the shorter the light-emitting time of the light-emitting diode D is, and the later the dimming time is, the longer the light-emitting time of the light-emitting diode D is. As compared with the related art, the present disclosure can perform adjustment within the entire light-emitting time zone to expand the selection range of the dimming time, and the flexible setting of the dimming time is more advantageous to achieving high contrast at low gray levels.

The present disclosure further provides a display panel. The display panel comprises the pixel drive circuit as described in any of the above embodiments. In the present disclosure, the display panel is an LED display panel. Through using the pixel drive circuit provided by any of the embodiments of the present disclosure, the threshold voltage differences of the display panel are compensated for. The light-emitting time at low gray levels are adjusted. Therefore, the uniformity of the picture is improved and the high contrast of the picture is achieved at the same time, and the display effect is improved.

The present disclosure provides a pixel drive circuit and a display panel. The pixel drive circuit comprises: a reference voltage input module configured to input a reference voltage to a first node under a control of a first control signal in a first working state; a light-emitting module connected to the reference voltage input module through the first node, and being configured to emit light under controls of a second control signal and a potential at the first node; a sensing module connected to the light-emitting module through a second node, and being configured to sense a threshold voltage of the light-emitting module under a control of a third control signal; a storage capacitor module connected to the light-emitting module through the first node, the second node and a third node, and being configured to store the threshold voltage of the light-emitting module; and a digital signal input module connected to the reference voltage input module and the light-emitting module through the first node, and being configured to input a data signal to the first node under a control of a fourth control signal in a second working state. The reference voltage input module is further configured to input the reference voltage to the first node under the control of the first control signal in a third working state after the light-emitting module emits light, so as to control the light-emitting module not to emit light. According to the present disclosure, the threshold voltage of the light-emitting module is obtained and stored in the first working state, the threshold voltage differences can be compensated for after the data signal is written in the second working state, and the light-emitting module can be controlled by inputting the reference voltage to stop emitting light in the third working state. The light-emitting time is shortened. As a result, the pixel drive circuit according to the present disclosure can improve uniformity of the picture and achieve high contrast at the same time, and the display effect is improved.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A pixel drive circuit comprising:
a reference voltage input module configured to input a reference voltage to a first node under a control of a first control signal in a first working state;
a light-emitting module connected to the reference voltage input module through the first node, and being configured to emit light under controls of a second control signal and a potential at the first node;
a sensing module connected to the light-emitting module through a second node, and being configured to sense a threshold voltage of the light-emitting module under a control of a third control signal;
a storage capacitor module connected to the light-emitting module through the first node, the second node and a third node, and being configured to store the threshold voltage of the light-emitting module; and
a digital signal input module connected to the reference voltage input module and the light-emitting module through the first node, and being configured to input a data signal to the first node under a control of a fourth control signal in a second working state;
wherein the reference voltage input module is further configured to input the reference voltage to the first node under the control of the first control signal in a third working state after the light-emitting module emits light, so as to control the light-emitting module not to emit light.

2. The pixel drive circuit as claimed in claim 1, wherein the reference voltage input module comprises a first transistor, a gate of the first transistor is connected to the first control signal, a first electrode of the first transistor is connected to a reference voltage input terminal, a second electrode of the first transistor is connected to the first node.

3. The pixel drive circuit as claimed in claim 2, wherein the light-emitting module comprises a second transistor, a third transistor and a light-emitting diode, a gate of the second transistor is connected to the second control signal, a first electrode of the second transistor is connected to the third node and a first power signal, a second electrode of the second transistor is connected to a first electrode of the third transistor, a gate of the third transistor is connected to the first node, a second electrode of the third transistor is connected to the second node and an anode of the light-emitting diode, a cathode of the light-emitting diode is connected to a second power signal.

4. The pixel drive circuit as claimed in claim 3, wherein the sensing module comprises a fourth transistor, a gate of the fourth transistor is connected to the third control signal, a first electrode of the fourth transistor is connected an initial voltage input terminal, a second electrode of the fourth transistor is connected to the second node.

5. The pixel drive circuit as claimed in claim 4, wherein the storage capacitor module comprises a first storage capacitor and a second storage capacitor, a first electrode plate of the first storage capacitor is connected to the first node, a second electrode plate of the first storage capacitor is connected to a first electrode plate of the second storage capacitor through the second node, a second electrode plate of the second storage capacitor is connected to the third node.

6. The pixel drive circuit as claimed in claim 5, wherein the digital signal input module comprises a fifth transistor, a gate of the fifth transistor is connected to the fourth control signal, a first electrode of the fifth transistor is connected to a data line, a second electrode of the fifth transistor is connected to the first node.

7. The pixel drive circuit as claimed in claim 1, wherein the reference voltage input module is configured to input the reference voltage to the first node under the control of the high-level first control signal in the first working state and the third working state.

8. The pixel drive circuit as claimed in claim 1, wherein the reference voltage input module is configured to input the high-level reference voltage in the first working state.

9. The pixel drive circuit as claimed in claim 1, wherein the reference voltage input module is configured to input the high-level reference voltage in the third working state.

10. The pixel drive circuit as claimed in claim 1, wherein the first control signal, the second control signal, the third control signal, and the fourth control signal are generated by a timing controller.

11. A display panel comprising a pixel drive circuit, the pixel drive circuit comprising:
a reference voltage input module configured to input a reference voltage to a first node under a control of a first control signal in a first working state;
a light-emitting module connected to the reference voltage input module through the first node, and being configured to emit light under controls of a second control signal and a potential at the first node;
a sensing module connected to the light-emitting module through a second node, and being configured to sense a threshold voltage of the light-emitting module under a control of a third control signal;
a storage capacitor module connected to the light-emitting module through the first node, the second node and a third node, and being configured to store the threshold voltage of the light-emitting module; and
a digital signal input module connected to the reference voltage input module and the light-emitting module through the first node, and being configured to input a data signal to the first node under a control of a fourth control signal in a second working state;
wherein the reference voltage input module is further configured to input the reference voltage to the first node under the control of the first control signal in a third working state after the light-emitting module emits light, so as to control the light-emitting module not to emit light.

12. The display panel as claimed in claim 11, wherein the reference voltage input module comprises a first transistor, a gate of the first transistor is connected to the first control signal, a first electrode of the first transistor is connected to a reference voltage input terminal, a second electrode of the first transistor is connected to the first node.

13. The display panel as claimed in claim 12, wherein the light-emitting module comprises a second transistor, a third transistor and a light-emitting diode, a gate of the second transistor is connected to the second control signal, a first electrode of the second transistor is connected to the third node and a first power signal, a second electrode of the second transistor is connected to a first electrode of the third transistor, a gate of the third transistor is connected to the first node, a second electrode of the third transistor is connected to the second node and an anode of the light-emitting diode, a cathode of the light-emitting diode is connected to a second power signal.

14. The display panel as claimed in claim 13, wherein the sensing module comprises a fourth transistor, a gate of the fourth transistor is connected to the third control signal, a first electrode of the fourth transistor is connected an initial voltage input terminal, a second electrode of the fourth transistor is connected to the second node.

15. The display panel as claimed in claim 14, wherein the storage capacitor module comprises a first storage capacitor and a second storage capacitor, a first electrode plate of the first storage capacitor is connected to the first node, a second electrode plate of the first storage capacitor is connected to a first electrode plate of the second storage capacitor through the second node, a second electrode plate of the second storage capacitor is connected to the third node.

16. The display panel as claimed in claim 15, wherein the digital signal input module comprises a fifth transistor, a gate of the fifth transistor is connected to the fourth control signal, a first electrode of the fifth transistor is connected to a data line, a second electrode of the fifth transistor is connected to the first node.

17. The display panel as claimed in claim 11, wherein the reference voltage input module is configured to input the reference voltage to the first node under the control of the high-level first control signal in the first working state and the third working state.

18. The display panel as claimed in claim 11, wherein the reference voltage input module is configured to input the high-level reference voltage in the first working state.

19. The display panel as claimed in claim 11, wherein the reference voltage input module is configured to input the high-level reference voltage in the third working state.

20. The display panel as claimed in claim 11, wherein the first control signal, the second control signal, the third control signal, and the fourth control signal are generated by a timing controller.
